(19) United States
(12) Patent Application Publication
(10) Pub. No.: US 2024/0343164 A1
(43) Pub. Date: Oct. 17, 2024

(54) Device for Anchoring a Seat in a Motor Vehicle

(71) Applicant: Bayerische Motoren Werke Aktiengesellschaft, Muenchen (DE)

(72) Inventor: Steffen HOFER, Petershausen (DE)

(21) Appl. No.: 18/683,314

(22) PCT Filed: Aug. 1, 2022
(86) PCT No.: PCT/EP2022/071535

§ 371 Date: Feb. 13, 2024

(30) Foreign Application Priority Data
Sep. 1, 2021 (DE) 10 2021 122 645.7

(51) Int. Cl. B60N 2/005

(52) U.S. Cl. CPC B60N 2/005

(57) ABSTRACT

A device is provided for anchoring a seat of a motor vehicle on a vehicle floor, wherein, on its lower side, the seat has at least one seat rail which extends in an X-direction of the motor vehicle. An adapter plate is arranged underneath at one end of the seat rail in a Z-direction, which adapter plate has a first hook which extends at one end of the seat rail downwards in the Z-direction and back again in the X-direction of the seat rail. The vehicle floor has an attachment pot, with a first aperture and a second aperture which extend in the X-direction. The first hook can be introduced downwards in the Z-direction into the first aperture and can be displaced in the X-direction until the hook is hooked onto a stop which is arranged within the attachment pot and is oriented in a Y-direction. One and the same device can be used for seats of different widths, and can be used for different Y-positions of the seat reference point in different vehicle derivatives.

### BACKGROUND AND SUMMARY

The invention relates to a device for anchoring a seat in a motor and to a motor vehicle having such a device.

A seat fastening for a vehicle seat is known for example from the German laid-open specification DE 10 2014 208 142 A1. A description is given of a vehicle seat with at least one body-side seat fastening which locks the vehicle seat in its normal position to a body in a crash-safe manner and which, for removal purposes, unlocks the vehicle seat into a removal position in relation to the body and which, with the body-side locking maintained, allows the vehicle seat to be folded into a folded position and/or, in the case of a backrest having been previously folded onto a seat part, into a rolled-over position, in which position(s) the seat fastening fixed to the body accommodates a torque and supports the vehicle seat in relation to the body.

Furthermore, a device for anchoring a seat on a vehicle floor is known from the German laid-open specification DE 102 01 622 A1. In a device for anchoring a load on a vehicle floor by way of a longitudinally extending rail composed of metallic material that is connected fixedly to said vehicle floor and has, cross-sectionally, an undercut region configured for sliding guidance of a carriage and a plurality of apertures, arranged at regular intervals, at a longitudinal groove, the carriage contains an elongate pair of strip elements which are connected fixedly to one another and which have a sliding member composed of plastic that is configured for sliding guidance in the undercut region of the rail. Such a sliding member—for example in the form of a channel profile whose limbs engage over the longitudinal edges of the assigned strip element—is arranged on the end of the carriage, preferably on both ends thereof.

A further seat with a seat attachment on a body is known for example from the American patent with the patent number U.S. Pat. No. 7,866,689 B2.

A disadvantage with the known seat fastenings for a motor vehicle is the fact that the seat fastenings cannot be used for different Y positions of the seat reference point (SRP), for example in different vehicle derivatives.

It is an object of the present invention to provide a device for anchoring a seat for a motor vehicle that is suitable for different Y positions of the seat reference point (SRP) in different vehicle derivatives.

This object is achieved by the features of the independent claim in that the seat has at its bottom side at least one seat rail which extends in an X direction of the motor vehicle, wherein, at one end of the seat rail, an adapter plate is arranged at the bottom in a Z direction, which adapter plate has at least a first, L-shaped hook which extends at one end of the seat rail downward in the Z direction and back again in the direction of the seat rail in the X direction, wherein the vehicle bottom has an attachment pot with at least a first aperture and a second aperture which extend in the X direction, wherein the first hook is introducible downward in a Z direction into the first aperture and is displaceable therein in the X direction until the hook is hooked onto a stop which is arranged within the attachment pot and which is oriented in a Y direction.

Owing to the configuration according to the invention of the device for anchoring a seat for a motor vehicle on a vehicle floor, simple mounting is ensured, wherein one and the same device may be used for seats of different widths or may be used for different Y positions of the seat reference point in different vehicle derivatives. The more apertures the attachment pot has, the greater the number of consequently possible Y positions for the attachment. It is advantageously possible for the attachment pot to be of modular design on the bodyshell side, which results in there being no increase in the number of variants owing to different seat positions. The attachment of the seat is consequently realized via the stop arranged in the attachment pot in the Y-direction, which stop is preferably designed as a rod. The attachment pot may in this case be formed for example by the underfloor, or as a separate component which is connected to the underfloor, for example is welded to the underfloor.

Advantageous refinements of the invention are described in the dependent claims.

In a particular development, on the adapter plate, there is arranged a second hook, oriented parallel to and spaced apart from the first hook, which is introducible downward in a Z direction into the second aperture, oriented parallel to and spaced apart from the first aperture, and which is displaceable therein in the X direction until the first and second hooks are hooked onto the stop. The stability of the device according to the invention is significantly increased by a double attachment to the attachment pot.

In a further development, adjacent to the first hook or between the first hook and the second hook, the adapter plate has a slot in the X-Z plane and, in the region of the slot, the adapter plate has a bore which is oriented perpendicularly to the slot, wherein a guide rod is introducible into the bore, wherein a locking element is pivotably arrangeable about the guide rod radially at the outside and is introducible into the attachment pot in a third aperture, which is oriented parallel to and is spaced apart from the first aperture, wherein an end face of the locking element is pressable against the stop on the side which is situated opposite the first hook, any tolerances in the X direction are compensated. Furthermore, this measure results in the overall stability of the device according to the invention being significantly increased once again.

In a yet further development, a compensation element is arranged between the first hook and the locking element so as to be pivotable about the guide rod radially at the outside and, in the installed state of the seat, is supported on the attachment pot, on the one hand, and, via a spring force of a spring element, on the adapter plate, on the other hand, the installation of the seat into the vehicle is significantly facilitated.

In a still further development, in the region of the locking element, the compensation element has a cutout into which the locking element is latchable in the installed state of the seat, locking of the whole device is achieved.

In a further development, a sliding bushing is arranged between the guide rod and the locking element so as to be coaxial with respect to the guide rod, the internal friction of the whole device is reduced, whereby the installation of the seat into the motor vehicle is facilitated.

The same effect as with the sliding bushing is achieved in that a sliding disk is arranged on the guide rod between the locking element and the compensation element so as to be coaxial with respect to the guide rod.

In a further development, a fourth aperture, oriented parallel to the first and second apertures, is provided on the side situated opposite the second aperture so as to be spaced apart from the first aperture, into which fourth aperture the first or the second hook is introducible, it being possible for there to be provided different Y positions of the seat reference point (SRP) in different vehicle derivatives in a first Y position.

In another development, a fifth aperture, oriented parallel to the first and second apertures, is provided on the side situated opposite the first aperture so as to be spaced apart from the second aperture, into which fifth aperture the first or the second hook is introducible, it being possible for there to be provided different Y positions of the seat reference point (SRP) in different vehicle derivatives in a second Y position.

Furthermore, a motor vehicle having a device for anchoring a seat is also disclosed.

### BRIEF DESCRIPTION OF THE DRAWINGS

FIG. 1 shows a view of a device according to an embodiment of the invention.

FIG. 2 shows a view from below of the device.

FIG. 3 shows a view of an attachment pot.

FIG. 4 shows the device in a first geometrical position.

FIG. 5 shows the device in a second geometrical position.

FIG. 6 shows the device in a third geometrical position.

FIG. 7 again shows a view of the device according to an embodiment of the invention.

FIGS. 8 to 13 show respective views of the individual components of the device.

FIGS. 14 to 18 show a mounting process for a seat.

FIGS. 19 to 21 show tolerance compensation in the X direction.

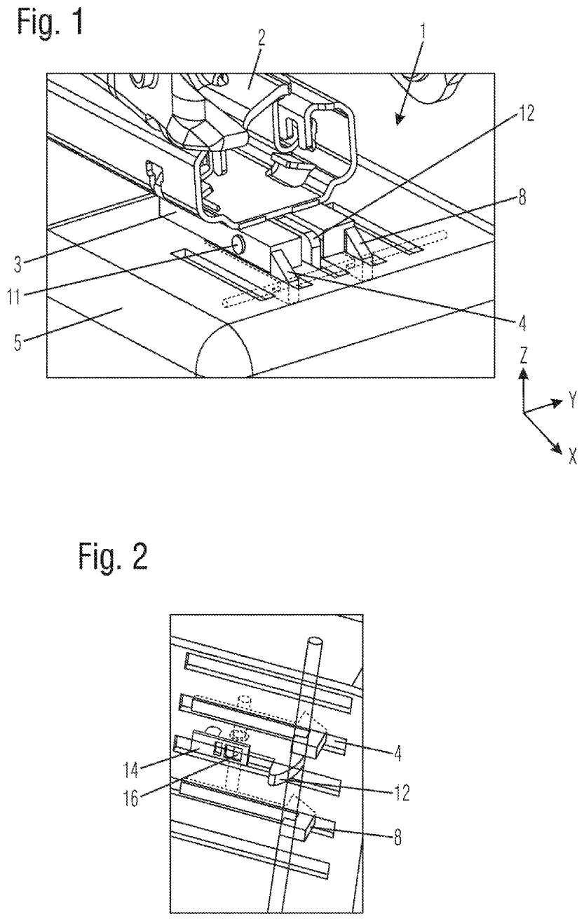

Below, the same reference numbering applies to identical structural elements in FIGS. 1 to 21, wherein not all the figures are numbered so as not to detract from the clarity of the illustrations.

### DETAILED DESCRIPTION OF THE DRAWINGS

FIG. 1 shows a view of a device 1 for anchoring a seat of a motor vehicle on a vehicle floor (not illustrated). Motor vehicle is to be understood in this case as meaning not only a passenger motor vehicle, it rather being the case that any kind of motor vehicle for roads or terrains is possible.

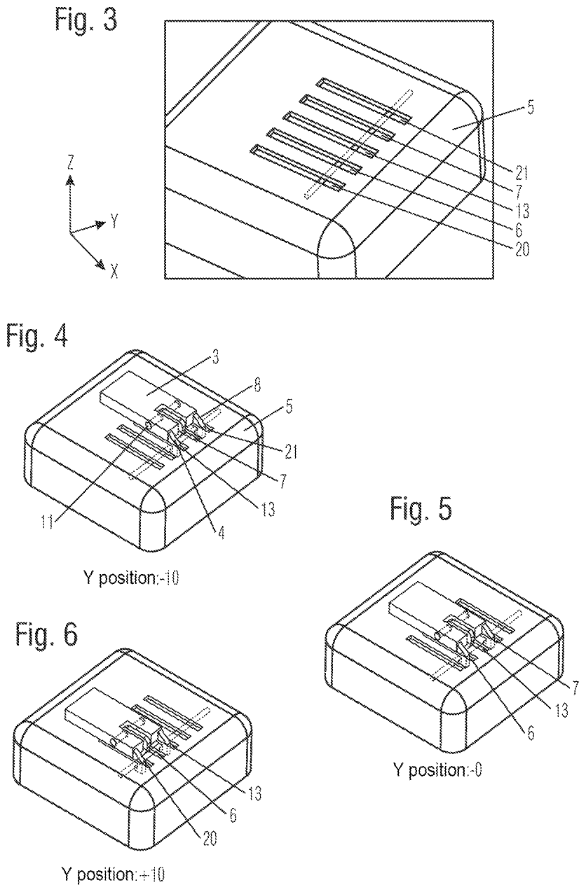

A seat (not illustrated) has at its bottom side at least one seat rail 2 (seats for motor vehicles normally having two seat rails 2), which extends in an X direction of the motor vehicle. X direction is to be understood in this case as meaning a vehicle longitudinal direction. Y direction is to be understood as meaning a vehicle transverse direction, and Z direction is to be understood as meaning a vehicle vertical direction. A corresponding coordinate system is illustrated in FIGS. 1 and 3.

At one end of the seat rail 2, in the present exemplary embodiment the front end, an adapter plate 3 is arranged at the bottom in a Z direction. In the present exemplary embodiment, the adapter plate 3 has a first hook 4 and a second hook 8. The first hook 4 and the second hook 8 extend at the end of the seat rail 2 firstly downward in the Z direction and further back in the direction of the seat rail 2.

Furthermore, the vehicle floor has an attachment pot 5, which in the present exemplary embodiment has five apertures 6, 7, 13, 20, 21 (numbered in FIG. 3) that extend in the X direction. The attachment pot 5 may be formed directly by the vehicle floor or be fastened, for example by welding, to the vehicle floor as a separate component on the vehicle floor. A first aperture in the attachment pot 5 is labelled 6, a second aperture is labelled 7. When the device is mounted, the first hook 4 is introducible downward in a Z direction into the first aperture 6 and is displaceable therein in the X direction until the first hook 4 is hooked onto a stop 9 (visible in FIG. 2) which is arranged within the attachment pot 5 and is oriented in a Y direction.

The same also applies to the second hook 8, which is introducible into the second aperture 7. In the present exemplary embodiment, the stop 9 is designed as a round bar which is welded into the attachment pot 5. In another exemplary embodiment, it is also possible for the attachment pot 5 itself to be designed as a stop at the end of the apertures 6, 7.

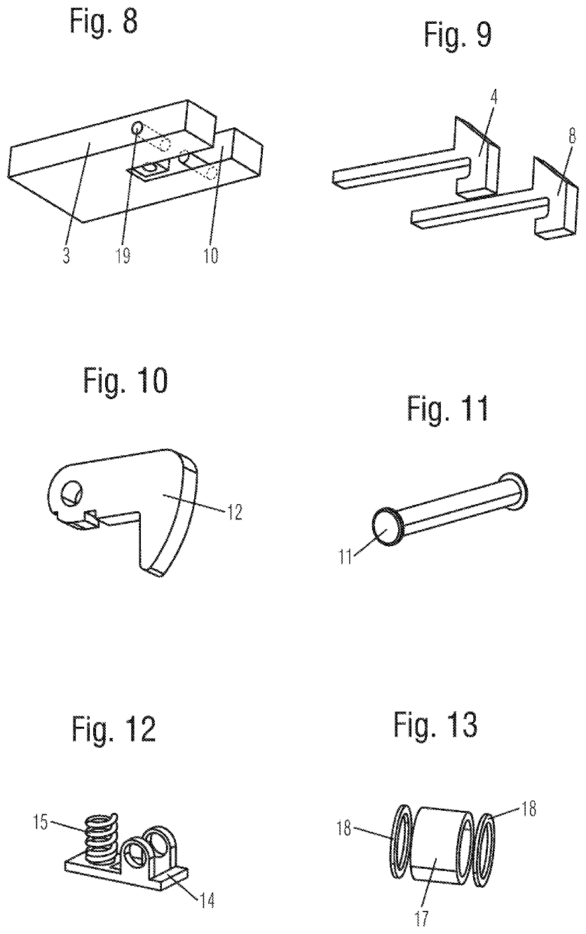

Furthermore, between the first hook 4 and the second hook 8, the adapter plate 3 has a slot 10 (visible in FIG. 8) in the X-Z plane and, in the region of the slot 10, the adapter plate 3 has a bore 19 (likewise visible in FIG. 8) which is oriented perpendicularly to the slot 10. In another exemplary embodiment, the slot 10 may also be arranged only adjacent to the first hook 4, if a second hook 8 is not provided. A guide rod 11 is introducible into the bore 19. A locking element 12 is pivotably arrangeable about the guide rod 11 radially at the outside and is introducible into the attachment pot 5 in a third aperture 13 (illustrated in FIG. 3), which is oriented parallel to and is spaced apart from the first aperture 6, by way of pivoting about the guide rod 11. An end face of the locking element 12 is pressable against the stop 9 on the side which is situated opposite the first hook 4.

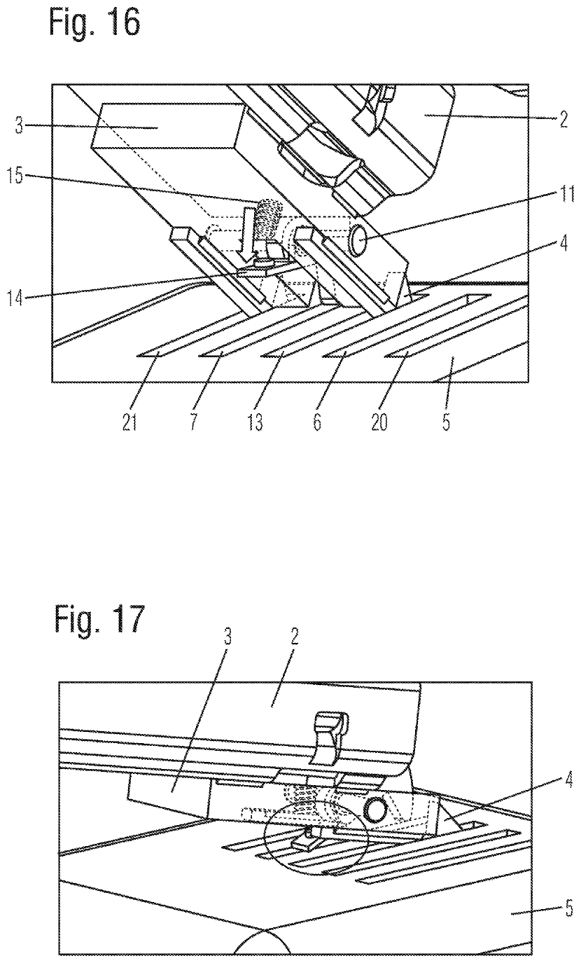

Furthermore, a compensation element 14 is arranged between the first hook 4 and the locking element 12 so as to be pivotable about the guide rod 11. In the present exemplary embodiment, the compensation element 14 is arranged between the first hook 4 and the second hook 8 and the locking element 12 so as to be pivotable about the guide rod 11. The locking element 12 can for example be seen from below in FIG. 2. In the installed state of the seat, the locking element 12 is supported on the attachment pot 5, on the one hand, and, via a spring force of a spring element 15 (illustrated in FIG. 16), on the adapter plate 3, on the other hand.

FIG. 2 shows a view from below of the device 1. It can furthermore be seen in FIG. 2 that, in the region of the locking element 12, the compensation element 14 has a cutout 16 into which the locking element 12 is latchable in the installed state of the seat.

In a preferred embodiment, for friction minimization purposes, a sliding bushing 17 (illustrated in FIG. 13) is arranged between the guide rod 11 and the locking element 12 so as to be coaxial with respect to the guide rod 11. A further reduction in the friction is achieved in that a sliding disk 18 (likewise illustrated in FIG. 13) is arranged on the guide rod 11 between the locking element 12 and the compensation element 14 so as to be coaxial with respect to the guide rod 11.

FIG. 3 shows a view of an attachment pot 5 having the five apertures 6, 7, 13, 20 and 21. The two apertures 20, 21 serve for adaptation of the Y position of the device 1.

FIGS. 4, 5 and 6 illustrate the effect according to the invention, the Y adaptation of the seat fastening. The more apertures 6, 7, 13, 20 and 21 the attachment pot 5 has, the greater the number of possible Y positions of the attachment.

FIG. 4 shows a first Y position of the device 1, with −10 mm in the Y direction.

FIG. 5 shows a second Y position of the device 1, with a Y position of +/−0 mm.

FIG. 6 shows a third Y position of the device 1, with a Y position of +10 mm.

As can be seen from FIGS. 4 to 6, the device 1 may be used either for seats of different widths or for different Y positions of the seat reference point (SRP), and may thus be used in different vehicle derivatives.

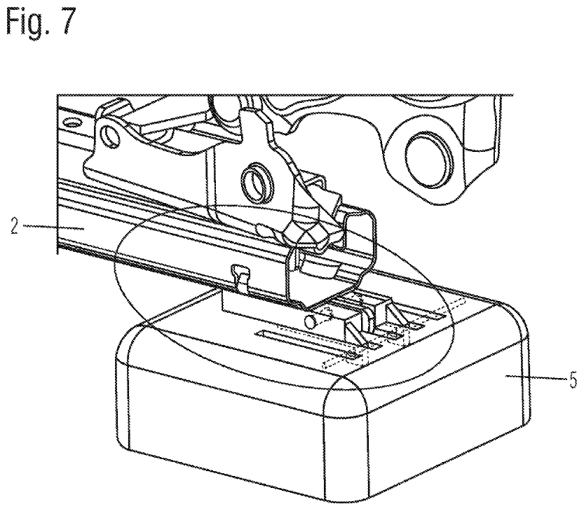

FIG. 7 again shows a view of the device 1, according to FIG. 1. In FIG. 7, the device 1 is illustrated encircled, and, in FIGS. 8 to 13, the individual structural elements of the encircled device 1 are illustrated.

FIG. 8 shows a view of the adapter plate 3 with the slot 10 and the bore 19.

FIG. 9 shows a view of the first hook 4 and the second hook 8. In the present exemplary embodiment, the adapter plate 3 consists of three individual components, that is to say the adapter plate 3, the first hook 4 and the second hook 8 are provided as separate components. These may for example be welded together or soldered together. In another exemplary embodiment, it is also possible for the adapter plate 3 to be provided with the first and second hooks 4, 8 as a single component. This may be realized for example by sintering or milling or casting.

FIG. 10 shows a view of the locking element 12 with a bore (not numbered), into which the guide rod 11 is introducible, and two notches (not numbered) for latching to the cutout 16 in the compensation element 14 after the installation of the seat in the motor vehicle.

FIG. 11 shows a view of the guide rod 11, which is able to be pushed through the bores in the adapter plate 3, the locking element 12 and the compensation element 14.

FIG. 12 shows a view of the compensation element 14 and of the spring element 15.

FIG. 13 shows a view of the sliding bushing 17 and two sliding disks 18 for reducing the internal friction in the device 1 according to the invention.

FIGS. 14 to 18 subsequently illustrate a mounting process for the seat using the device 1.

FIG. 14 shows a view of the device 1 at the beginning of the mounting of the seat in the motor vehicle. In a first step, the seat is positioned by way of the first hook 4 and the second hook 8 into the first aperture 6 and the second aperture 7 in the attachment pot 5.

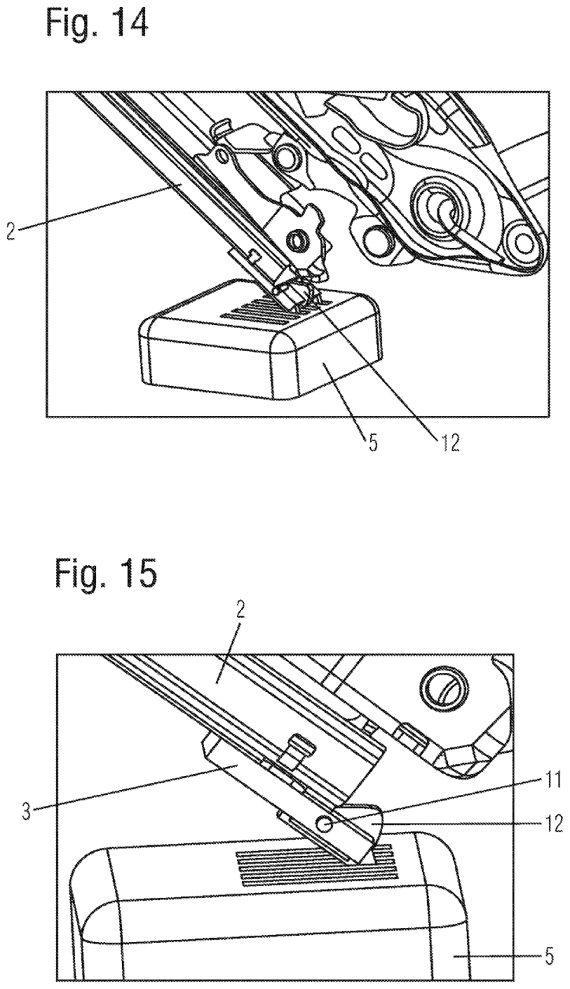

Afterwards, the seat, in FIG. 15, is pulled back in the X direction until the first and second hooks 4, 8 bear against the stop 9 within the attachment pot 5.

FIG. 16 illustrates how the spring element 15, in the present exemplary embodiment a spiral spring, pushes the compensation element 14 and the locking element 12 into an “open” position. This means that the locking element is “open” and the seat can “virtually” be installed. Without this position, it is not possible to realize “hooking” of the seat into the connection pot by way of the transverse bolts.

FIG. 17 shows how, during the lowering of the seat, this locks the compensation element 14 and the locking element 12 through the inherent weight of the seat. At the same time, latching occurs between the cutouts of the locking element 12 and the cutout 16 in the compensation element 14 (illustrated encircled).

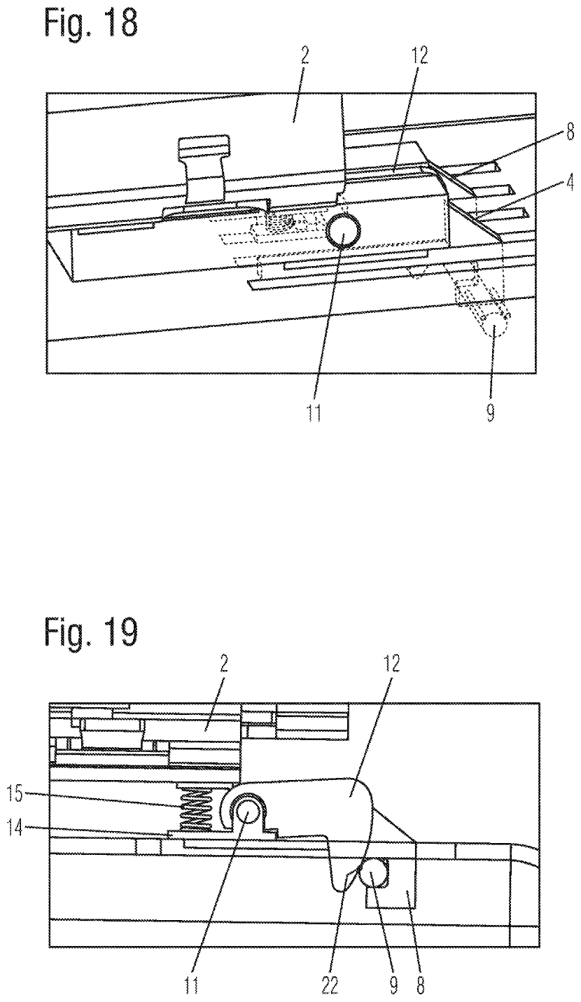

FIG. 18 shows a view of the device 1 for the completely mounted and latched seat.

FIG. 19 shows an X-Z section through the device 1, wherein the section extends adjacent to the locking element 12. In FIG. 19, no tolerances are to be compensated in the X direction, that is to say the locking element 12 bears against the stop 9 at a defined point, the point of contact 22.

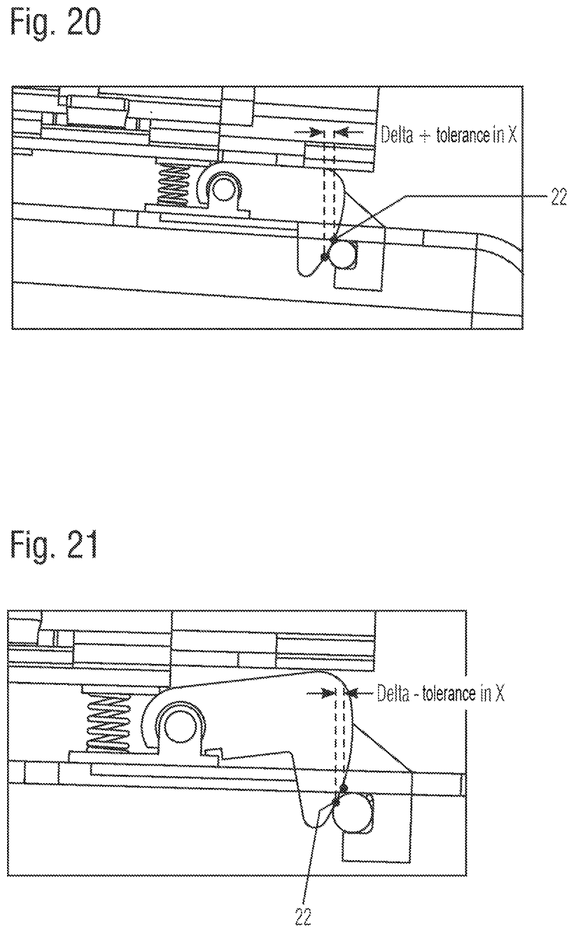

In FIG. 20, the whole device has a small tolerance in the +X direction. Consequently, the locking element 12 projects deeper into the third aperture 13, so that the point of contact 22 between the locking element 12 and the stop 9 is shifted upward on the locking element 12.

By contrast, FIG. 21 shows, in the case of a tolerance in the −X direction, that the point of contact 22 between the locking element 12 and the stop 9 is moved downward on the locking element 12.

Altogether, it can be stated that, with the configuration of the device 1, perfect tolerance compensation in the X direction is ensured.

Owing to the configuration of the device 1 for anchoring a seat of a motor vehicle on a vehicle floor, simple mounting is ensured, wherein one and the same device 1 may be used for seats of different widths or may be used for different Y positions of the seat reference point (SRP) in different vehicle derivatives.

### LIST OF REFERENCE SIGNS

1. Device
2. Seat rail
3. Adapter plate
4. First hook
5. Attachment pot
6. First aperture
7. Second aperture
8. Second hook
9. Stop
10. Slot
11. Guide rod
12. Locking element
13. Third aperture
14. Compensation element
15. Spring element
16. Cutout
17. Sliding bushing
18. Sliding disk
19. Bore
20. Fourth aperture
21. Fifth aperture
22. Point of contact
X Vehicle longitudinal direction
Y Vehicle transverse direction
Z Vehicle vertical direction

1-10. (canceled)

11. A device for anchoring a seat of a motor vehicle on a vehicle floor, comprising:
at least one seat rail which extends in an X direction of the motor vehicle on a bottom side of the seat;
an adapter plate arranged at a bottom, at one end of the seat rail, in a Z direction, the adapter plate having at least a first, L-shaped hook which extends at one end of the seat rail downward in the Z direction and back again in the direction of the seat rail in the X direction;
an attachment pot of the vehicle floor, the attachment pot having at least a first aperture and a second aperture which extend in the X direction, wherein
the first hook is introducible downward in the Z direction into the first aperture and is displaceable therein in the X direction until the first hook is hooked onto a stop, which stop is arranged within the attachment pot and oriented in a Y direction.

12. The device according to claim 11, wherein,
on the adapter plate, there is arranged a second hook, oriented parallel to and spaced apart from the first hook, which is introducible downward in the Z direction into the second aperture, oriented parallel to and spaced apart from the first aperture, and which is displaceable therein in the X direction until the first and second hooks are hooked onto the stop.

13. The device according to claim 12, wherein,
adjacent to the first hook or between the first hook and the second hook, the adapter plate has a slot in an X-Z plane and, in a region of the slot, the adapter plate has a bore which is oriented perpendicularly to the slot,
a guide rod is introducible into the bore,
a locking element is pivotably arrangeable about the guide rod and is introducible into the attachment pot in a third aperture, which is oriented parallel to and is spaced apart from the first aperture, and
an end face of the locking element is pressable against the stop on a side which is situated opposite the first hook.

14. The device according to claim 13, further comprising:
a compensation element arranged between the first hook and the locking element so as to be pivotable about the guide rod, wherein
in an installed state of the seat, the compensation element is supported on the attachment pot, on the one hand, and, via a spring force of a spring element, on the adapter plate, on the other hand.

15. The device according to claim 14, wherein,
in the region of the locking element, the compensation element has a cutout into which the locking element is latchable in the installed state of the seat.

16. The device according to claim 13, wherein
a sliding bushing is arranged between the guide rod and the locking element so as to be coaxial with respect to the guide rod.

17. The device according to claim 14, further comprising:
a sliding disk arranged on the guide rod between the locking element and the compensation element so as to be coaxial with respect to the guide rod.

18. The device according to claim 11, wherein
a fourth aperture, oriented parallel to the first and second apertures, is provided in the adaptor on the side situated opposite the second aperture so as to be spaced apart from the first aperture, into which fourth aperture the first or the second hook is introducible.

19. The device according to claim 11, wherein
a fifth aperture, oriented parallel to the first and second apertures, is provided in the adaptor pot on the side situated opposite the first aperture so as to be spaced apart from the second aperture, into which fifth aperture the first or the second hook is introducible.

20. A motor vehicle comprising a device for anchoring a seat according to claim 11.
